(19) United States
(12) Patent Application Publication
(10) Pub. No.: US 2019/0261662 A1
(43) Pub. Date: Aug. 29, 2019

(54) ALL-NATURAL HOT DOG

(71) Applicant: Conagra Foods RDM, Inc., Chicago, IL (US)

(72) Inventors: Cortney M. Ballard, Papillion, NE (US); Jairus R.D. David, Omaha, NE (US)

(21) Appl. No.: 16/282,480

(22) Filed: Feb. 22, 2019

Related U.S. Application Data
(60) Provisional application No. 62/634,284, filed on Feb. 23, 2018.

(51) Int. Cl. A23L 13/60; A23L 13/40

(52) U.S. Cl. CPC A23L 13/65; A23V 2002/00; A23L 13/428

(57) ABSTRACT

An all-natural hot dog including cultured celery juice powder, cherry powder, dried distilled vinegar, and natural liquid smoke and containing no nitrates or nitrites except for those naturally occurring in sea salt and cultured celery juice powder, where the hot dog has substantially equivalent or superior properties to a hot dog containing chemical additives.

### RELATED APPLICATION

The present application claims the benefit under 35 U.S.C. 119(e) of U.S. Provisional Application Ser. No. 62/634,284 filed Feb. 23, 2018, entitled “All-Natural Hot Dog”.

### BACKGROUND

Hot dogs (also referred to as wieners, frankfurters, and franks) are made from one or more ground meats encased in a casing. They may include flavorings and colorants and are generally sold precooked (although typically they are heated prior to eating). To prevent spoilage, hot dogs typically include chemical preservatives and they usually include other chemical additives to impart desired color and flavor.

### SUMMARY

This summary is provided solely as an introduction to subject matter that is fully described in the detailed description and drawings. The summary should not be considered to describe essential features nor be used to determine the scope of the claims. Moreover, it is to be understood that both the summary and the detailed description are examples and explanatory only and are not necessarily restrictive of the subject matter claimed.

Aspects of the disclosure include a hot dog containing a combination of all-natural ingredients which collectively cause the inhibition of microbial growth as well as desired taste, color, and other qualities. Other aspects of the disclosure include a method of making a hot dog containing all-natural ingredients and having substantially equal or superior qualities as hot dogs made with chemical additives.

### BRIEF DESCRIPTION OF THE FIGURES

FIG. 1 is a chart illustrating the results of toxicity testing for C. botulinum. Positive Control 0 is the positive growth control. There are three negative controls—60, 80, and 100 (indicating the amount of nitrate in ppm).

FIG. 2 is a second chart illustrating the results of toxicity testing for C. botulinum using two types of vinegar products. DDV indicates dried distilled vinegar (N6) and VC indicates a blend of liquid vinegar and cultured sugar (N64). 60, 80, and 100 indicate the amounts of nitrate in ppm.

### DETAILED DESCRIPTION

People have been using chemical additives in foods for thousands of years. Additives are used to impart qualities such as safety, freshness, nutritional value, taste, texture, and appearance. The use of food additives became more prominent in the past 50 years or so due to the increased production of prepared, processed, and convenience foods. However there has been a backlash of sorts more recently, with many consumers desiring the convenience of prepared foods but without the chemical additives that have been thought necessary. In addition, there has been a push by consumers for products having fewer additives, particularly additives having names they do not know how to pronounce or cannot define. Yet, removing chemical additives can have major effects on the safety and the organoleptic properties of food. The food industry is innovating to provide all-natural products to meet current consumer demand in the market place.

As used herein the term “additive” means a substance added to a food product for a specific purpose. Examples include phosphates used in meat and poultry products to retain moisture and protect the flavor and sweeteners used to impart a specific taste.

As used herein the term “chemical additive” means an additive that is produced by chemical means, such as by direct synthesis or via a chemical isolation method.

As used herein the term “all-natural” or “all-natural additive” or “natural additive” means an additive derived from a non-man-made source.

For example, sweeteners can be either chemical additives (high fructose corn syrup) or natural (honey). A color imparting additive can be a chemical additive (FD&C Red No. 40) or an all-natural additive (beet juice).

Listeria monocytogenes is a species of pathogenic bacteria that causes the infection listeriosis. L. monocytogenes may be present in meat, poultry, milk, and egg products and its presence and growth in these products can usually be controlled through proper manufacturing and consumer handling. Chemical additives are often added to at risk products for extra protection. For example, a combination of the preservatives sodium lactate and sodium diacetate is sometimes added to meat products, including hot dogs, to control the growth of L. monocytogenes.

Clostridium botulinum is a bacterium that produces the botulinum toxin, which can cause botulism. The preservative sodium nitrite is commonly added to certain foods such as hot dogs to control C. botulinum. The addition of sodium nitrite has additional functions and is said to “cure” a meat product. Curing is a complicated and not completely understood process which preserves the meat product from spoiling and adds a desired color and flavor. Hot dogs sometimes list sodium nitrate as an ingredient; sodium nitrate is simply a precursor of sodium nitrite and must be converted to sodium nitrite for curing activity.

In addition to sodium lactate, sodium diacetate, and sodium nitrite, hot dogs and other sausages commonly also include a chemical additive as a cure accelerant which acts as a catalyst for the conversion of nitrite to nitric oxide. One common chemical cure accelerator is sodium erythorbate. In addition, many prior art hot dogs include artificial liquid smoke for flavor and hydrolyzed soy protein as a flavor enhancer. If a prior art hot dog uses a natural liquid smoke then it often includes an emulsifier such as polysorbate 60.

Aspects of the disclosure include hot dogs that contain none of the above discussed chemical additives but do contain a combination of four natural additives that have a collective effect of imparting food safety and desired organoleptic properties. The resulting all-natural hot dogs have substantially similar or better qualities as the prior art hot dogs containing chemical additives.

Vinegar is a dilute solution of acetic acid produced by the fermentation of ethanol by bacteria. Distilled vinegar is produced by the fermentation of distilled alcohol. Dried vinegar or vinegar powder is produced by drying distilled vinegar. The powder can be produced by fermentation using specifically selected food cultures. One example of dried distilled vinegar (DDV) is Verdad® Powder N6 produced by Corbion and which has a moisture content of about 9% to 15% (w/w) and free acidity of about 4.5% to 6.5% (w/w). The pH of a 10% aqueous solution is about 5.6 to 6.0. Dried vinegar may be used in an amount from about 0.3% to 1.2% by weight in hot dogs to effectively curtail the growth of L. monocytogenes. In another aspect, a liquid vinegar may be used for the same purposes in an amount which provides similar quantity of acetic acid. One example is Verdad® N64, sold by Corbion, which is a blend of vinegar and cultured sugar (VC).

Celery contains naturally occurring nitrates. Celery or celery juice can be treated with appropriate bacteria that turn the nitrates into nitrites and is then dried to make cultured celery powder. The product can be high in naturally occurring nitrites that are standardized with sea salt. One source of cultured celery juice powder is Florida Food Products of Eustis, Fla. which sells VegStable® 506 which is a water soluble dried powder consisting of celery powder and sea salt. Cultured celery juice powder can be used in an amount that provides a desired amount of nitrite based on meat green weight to provide antimicrobial properties to the meat product. The amount of nitrite can range from the minimum amount recommended by the controlling governmental regulation to about 500 ppm. Current USDA guidelines recommend a minimum of 120 ppm ingoing nitrite in all cured products designed to be kept refrigerated so an acceptable range can be about 120 ppm to 500 ppm. Cultured celery juice powder can also impart “cured” meat color and flavor to meat products such as hot dogs.

In other aspects, uncultured celery juice or celery juice powder can be used, and nitrate reductase or nitrate reductase containing microorganisms included in the formulation. In another aspect, other natural sources of nitrates or nitrites can be used, such as other vegetables such as lettuce, spinach, chard, or beets, either in dried or liquid form, and optionally cultured to reduce nitrates to nitrites or paired with reductase.

Cherry powder can be produced from cherries which contain a high amount of ascorbic acid (vitamin C). Dried cherry powder can function as a cure accelerator. Cherry powder can be used in an amount from about 250 ppm to 469 ppm. One source of dried cherry powder is Florida Food Products in Eustis, Fla., which sells VegStable® 525. This product can be derived from fresh cherries and includes some sea salt and optionally a caking agent such as silicon dioxide.

Other embodiments contain another or an additional all-natural source of ascorbic acid such as Acerola cherry powder.

Natural liquid smoke is a condensate of smoke created from wood using heat, water, and filtration. The natural liquid spoke can be used in an amount that provides the desired flavor. The ingredient can be an aqueous smoke flavor produced by controlled pyrolysis of wood. An example of a suitable product is sold by Red Arrow Products of Manitowoc, Wis. as Charsol RA07033. This component is applied external to the product prior to a cooking step, and its primary function is in imparting flavor. In one aspect the product is exposed for 30 to 90 seconds to a liquid smoke having a titratable acidity of about 1.7 to 2.3.

In some embodiments, the composition can include an antioxidant such as a natural clean label antioxidant such as rosemary extract or green tea extract for protecting product against color change or lipid or flavor oxidation.

The composition is a product including all-natural additives. It contains no nitrates or nitrites beyond those in the cultured celery juice powder, or another all-natural nitrate or nitrite source.

The hot dogs can be made by processes, including grinding the meat, blending the ingredients, stuffing, and cooking the hot dogs. The all-natural additives can be added in the same manner and at the same timing as chemical additives. For example, the all-natural additives may be added during the blending stage except for the liquid smoke which is added at or prior to the cooking stage.

### Example 1: Consumer Testing

Two hot dog products were made using all-natural additives and compared against a prior art product which includes chemical additives. The ingredients of the products are shown in Table 1. “Yes” indicates presence of the additive, “--” indicates the additive was not present. Two versions of the all-natural hot dog were compared, one containing a vinegar and cultured cane sugar product (VC) and one containing dried distilled vinegar (DDV).

TABLE 1

| | | All-Natural | All-Natural |
|---|---|---|---|
| | Prior Art | Hot Dog | Hot Dog |
| | Hot Dog | VC | DDV |
| Beef | Yes | Yes | Yes |
| Water | Yes | Yes | Yes |
| Salt, spice | Yes | Yes | Yes |
| Sodium lactate | Yes | — | — |
| Sodium diacetate | Yes | — | — |
| Sodium nitrite | Yes | — | — |
| Sodium erythrobate | Yes | — | — |
| Hydrolyzed soy powder | Yes | — | — |
| Natural liquid smoke with | Yes | — | — |
| polysorbate 60 | | | |
| Cultured celery juice powder | — | Yes | Yes |
| Cherry powder | — | Yes | Yes |
| Distilled vinegar (VC or DDV) | — | Yes (VC) | Yes (DDV) |
| Natural liquid smoke w/o | — | Yes | Yes |
| polysorbate 60 | | | |

The three products were consumer tested using side by side comparisons of each of the two new products versus the prior art product. For the “preference score” each of VC and DDV was compared against the prior art product which is why the total score is not 100%. Since “no preference” was a possible response, the score for each side by side also did not total 100%.

150 consumers were used for each comparison. For intensity measures a 10-point scale was used. Intensity scales measure the degree to which tasters rate the product in amount or intensity of attribute, not the degree to which they like the product. The preference score in Table 4 was measured after the consumer was presented with ingredients statements.

Tables 2 and 3 illustrate the results of the comparison tests.

TABLE 2

| | | All-Natural | All-Natural |
|---|---|---|---|
| | Prior Art | VC | DDV |
| Colorlight - dark | 5.55 | 5.7 | 6.0 |
| Overall Flavor | 6.35 | 5.9 | 6.2 |
| weak - strong | | | |
| Beef Flavor | 6.15 | 5.4 | 5.9 |
| weak - strong | | | |
| Saltiness | 5.25 | 4.5 | 4.6 |
| not at all - extremely | | | |
| Sweetness | 3.6 | 3.8 | 3.7 |
| not at all - extremely | | | |
| Spiciness | 4.15 | 3.7 | 4.0 |
| not at all - extremely | | | |
| Smokiness | 4.6 | 4.1 | 4.7 |
| not at all - extremely | | | |
| Firmness | 6.05 | 5.8 | 5.6 |
| Soft - firm | | | |
| Juiciness | 6.2 | 6.1 | 6.5 |
| dry - juicy | | | |
| Chewiness | 5.5 | 5.2 | 5.4 |
| not at all - extremely | | | |

TABLE 3

| | Prior Art | All-Natural VC | All-Natural DDV |
|---|---|---|---|
| Overall liking | 7.15 | 6.7 | 6.9 |
| Appearance | 6.8 | 6.6 | 6.9 |
| Aroma | 6.7 | 6.8 | 6.7 |
| Color | 6.9 | 6.8 | 6.9 |
| Flavor | 6.9 | 6.1 | 6.5 |
| Texture | 6.95 | 6.6 | 6.9 |
| Preference Score | 48% | 38% | 45% |

The results show that the scores for all three hot dog products were similar. The DDV product, with the dried distilled vinegar, tested better than the VC sample and achieved almost equivalent or better scores than the prior art product, containing chemical additives. By almost equivalent or substantially equivalent is meant that the product scored at least 90% of the compared product.

### Example 2: Resistance to Listeria monocytogenes Growth

The growth of L. monocytogenes in hot dogs made with all-natural additives was compared to growth in prior art hot dogs containing chemical antimicrobials. Storage at 4.4° C./40° F. for 130 days was tested as well as storage for the same time at 7° C./45° F. The sample designs are shown in Table 4. Sample 1 contained a common chemical additive used to control L. monocytogenes, a product containing 56% sodium lactate and 4% sodium diacetate (SLSD). Sample 2 contained none of this additive. Samples 3-8 contained an all-natural additive to inhibit growth of L. monocytogenes, a vinegar product, VC or DDV.

Samples 1 and 2 used a chemical nitrite at 131 ppm and samples 3-8 used a combination of a cultured celery juice powder in a range of nitrite from 60 to 100 ppm and Accerola cherry powder at 250 ppm.

Hot dogs were prepared with the formulations using typical procedures.

TABLE 4

| | | | % VC or | | | |
|---|---|---|---|---|---|---|
| | | % SLSD | DDV by | Temp | Temp | |
| | | by weight | weight | (° C.) | (° C.) | Table |
| 1 | Prior art- positive | 2.26% | | 4.4 | 7 | 5 |
| | control blend of | | | | | |
| | sodium lactate (56%) | | | | | |
| | and sodium diacetate | | | | | |
| | (4%) (131 ppm | | | | | |
| | nitrite) | | | | | |
| 2 | Negative control | 0 | | 4.4 | 7 | 6 |
| 3 | VC (100 ppm nitrite) | | 2.2% | 4.4 | 7 | 7 |
| 4 | VC (80 ppm nitrite) | | 2.2% | 4.4 | 7 | 8 |
| 5 | VC (60 ppm nitrite) | | 2.2% | 4.4 | 7 | 9 |
| 6 | DDV (100 ppm nitrite) | | 0.9% | 4.4 | 7 | 10 |
| 7 | DDV (80 ppm nitrite) | | 0.9% | 4.4 | 7 | 11 |
| 8 | DDV (60 ppm nitrite) | | 0.9% | 4.4 | 7 | 12 |

Tables 5 through 12 show the compositions of sample formulations 1 through 8.

TABLE 5
Positive Control - Sample #1

| Ingredient | % by weight |
|---|---|
| Beef | 80.41 |
| Ice | 12.58 |
| Salt | 1.34 |
| Spice blend | 3.32 |
| sodium lactate (56%)/sodium diacetate (4%) | 2.26 |
| 12.5% sodium nitrite | 0.08 |
| Total sodium nitrite in the formulation on meat block basis | 131 ppm |
| total | 100% |

TABLE 6
Negative Control - Sample #2

| Ingredient | % by weight |
|---|---|
| Beef | 82.27 |
| Ice | 12.87 |
| Salt | 1.37 |
| Spice blend | 3.40 |
| 12.5% sodium nitrite | 0.09 |
| Total sodium nitrite in the formulation on meat block basis | 131 ppm |
| total | 100% |

TABLE 7
VC (100 ppm nitrite) - Sample #3

| Ingredient | % by weight |
|---|---|
| Beef | 80.95 |
| Ice | 12.66 |
| Salt | 1.35 |
| Natural Spice blend | 2.51 |
| cultured celery juice powder | 0.22 |
| Cherry Powder | 0.12 |
| VC | 2.2 |
| Total sodium nitrite in the formulation on meat block basis | 100 ppm |
| total | 100% |

TABLE 8
VC (80 ppm nitrite) - Sample #4

| Ingredient | % by weight |
|---|---|
| Beef | 80.89 |
| Ice | 12.65 |
| Salt | 1.34 |
| Natural Spice blend | 2.5 |
| cultured celery juice powder | 0.29 |
| Cherry Powder | 0.12 |
| VC | 2.2 |
| Total sodium nitrite in the formulation on meat block basis | 80 ppm |
| total | 100% |

TABLE 9
VC (60 ppm nitrite) - Sample #5

| | % by |
|---|---|
| Ingredient | weight |
| Beef | 80.83 |
| Ice | 12.64 |
| Salt | 1.34 |
| Natural Spice blend | 2.5 |
| cultured celery juice powder | 0.36 |
| Cherry Powder | 0.12 |
| VC | 2.2 |
| Total sodium nitrite in the formulation on meat block basis | 60 ppm |
| total | 100% |

TABLE 10
DDV (100 ppm nitrite) - Sample #6

| | % by |
|---|---|
| Ingredient | weight |
| Beef | 81.91 |
| Ice | 12.81 |
| Salt | 1.36 |
| Natural Spice blend | 2.54 |
| cultured celery juice powder | 0.37 |
| Cherry Powder | 0.12 |
| DDV | 0.9 |
| Total sodium nitrite in the formulation on meat block basis | 100 ppm |
| total | 100% |

TABLE 11
DDV (80 ppm nitrite) - Sample #7

| | % by |
|---|---|
| Ingredient | weight |
| Beef | 81.97 |
| Ice | 12.82 |
| Salt | 1.36 |
| Natural Spice blend | 2.54 |
| cultured celery juice powder | 0.29 |
| Cherry Powder | 0.12 |
| DDV | 0.9 |
| Total sodium nitrite in the formulation on meat block basis | 80 ppm |
| total | 100% |

TABLE 12
DDV (60 ppm nitrite) - Sample #8

| | % by |
|---|---|
| Ingredient | weight |
| Beef | 82.03 |
| Ice | 12.83 |
| Salt | 1.36 |
| Natural Spice blend | 2.54 |
| cultured celery juice powder | 0.22 |
| Cherry Powder | 0.12 |
| DDV | 0.9 |
| Total sodium nitrite in the formulation on meat block basis | 60 ppm |
| total | 100% |

Five L. monocytogenes strains were used for inoculation, shown in Table 13.

TABLE 13

| Strain | Origen | Serotype |
|---|---|---|
| L. monocytogenes 101 | Hard salami isolate | 4b |
| L. monocytogenes 108 | Hard salami isolate | 1/2b |
| L. monocytogenes FSL-Cl- | Human isolate | 4b |
| 109 | | |
| L. monocytogenes 132 | Hard salami isolate | 1/2b |
| L. monocytogenes 310 | Goat milk cheese isolate | 4b |

A cocktail of the five strains was prepared and used for inoculations. The cocktail was used at 3 Log CFU/g. Whole packs of hotdogs were inoculated with 400 μl to achieve about 2.6 Log CFU/package then vacuum packed and stored at 4.4° C. and 7° C. Samples were analyzed every one to two weeks for 130 days or until L. monocytogenes increased greater than 3 Log CFU/package. On sample days, samples were tested for pathogens, pH, water activity, and moisture.

All the samples stored at 4.4° C. showed slight change in pH over 119 days. This indicates there was no significant acid production, so the control of L. monocytogenes was based on the antimicrobial dosage.

Table 14 illustrates L. monocytogenes growth in the hot dogs stored at 4.4° C.

TABLE 14

| | | 1 log | 2 log | 3 log |
|---|---|---|---|---|
| | | increase | increase | increase |
| | | (day) | (day) | (day) |
| 1 | Prior art - positive control blend of | 46 | 56 | 76 |
| | sodium lactate (56%) and sodium | | | |
| | diacetate (4%) | | | |
| 2 | Negative control | 31 | 38 | 46 |
| 3 | VC (100 ppm nitrite) | 66 | 76 | 87 |
| 4 | VC (80 ppm nitrite) | 38 | 56 | 66 |
| 5 | VC (60 ppm nitrite) | 46 | 61 | 76 |
| 6 | DDV (100 ppm nitrite) | 112 | 112 | >130 |
| 7 | DDV (80 ppm nitrite) | 112 | 112 | >130 |
| 8 | DDV (60 ppm nitrite) | 87 | 87 | 112 |

The negative control formulation increased 1 log outgrowth in 31 days, 2 log outgrowth in 38 days, and reached 7 log CFU/package in 56 days. The prior art formulation with 2.26% Sodium lactate and sodium diacetate blend controlled the outgrowth under 1 log until day 46, 2 log increase until day 56, and 3 log outgrowth until day 76. The treatment 2.2% VC with 60 ppm of nitrite shows equivalent inhibition as the prior art formulation whereas the treatment 2.2% VC with 100 ppm of nitrite showed higher inhibition. All the treatments with 0.9% DDV showed higher control of Listeria monocytogenes outgrowth.

No significant growth of lactic acid bacteria was detected in any of the formulations containing natural additives until day 119 at 4.4° C.

Table 15 illustrates L. monocytogenes growth in the hot dogs stored at 7° C./45° F.

TABLE 15

| | | 1 log | 2 log | 3 log |
|---|---|---|---|---|
| | | increase | increase | increase |
| | | (day) | (day) | (day) |
| 1 | Prior art - positive control blend of | 21 | 21 | 21 |
| | sodium lactate (56%) and sodium | | | |
| | diacetate (4%) | | | |
| 2 | Negative control | 13 | 21 | 21 |
| 3 | VC (60 ppm nitrite) | 21 | 35 | 35 |
| 4 | VC (80 ppm nitrite) | 21 | 28 | 28 |
| 5 | VC (100 ppm nitrite) | 21 | 28 | 35 |
| 6 | DDV (60 ppm nitrite) | 35 | 61 | 61 |
| 7 | DDV (80 ppm nitrite) | 46 | 53 | 61 |
| 8 | DDC (100 ppm nitrite) | 28 | 46 | 61 |

Samples 3 and 4 (VC at 60 and 80 ppm respectively), had similar inhibition as the prior art formulation whereas VC at 100 ppm (sample 5) is a little better. All samples with DDV exhibited better inhibition than the prior art formulation.

### Example 3: Resistance to C. botulinum Growth

The inhibition of growth of C. botulinum was tested at three temperatures, 4.4° C., 10° C., and 22° C. for the prior art hot dogs containing chemical additives and the hot dogs of the invention containing all-natural additives. The growth control did not contain antimicrobials, sodium nitrite, or sodium erythorbate. The negative growth control included 100 mg/kg sodium nitrite, 250 mg/kg sodium erythorbate, and 2.0% of the combination of sodium lactate and sodium diacetate (SLSD).

All-natural additives were cultured celery powder, cherry powder, and 0.9% DDV or 2.2% VC.

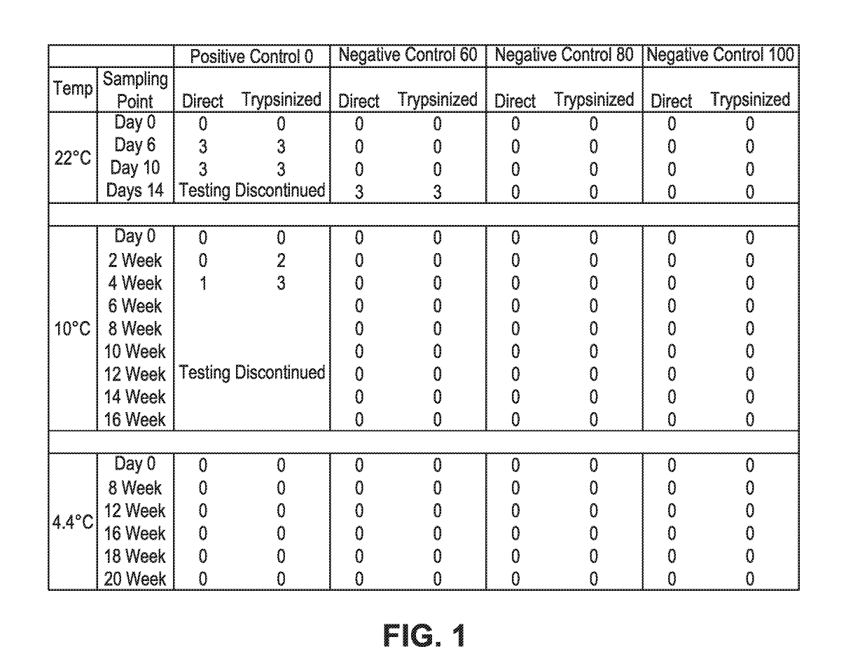

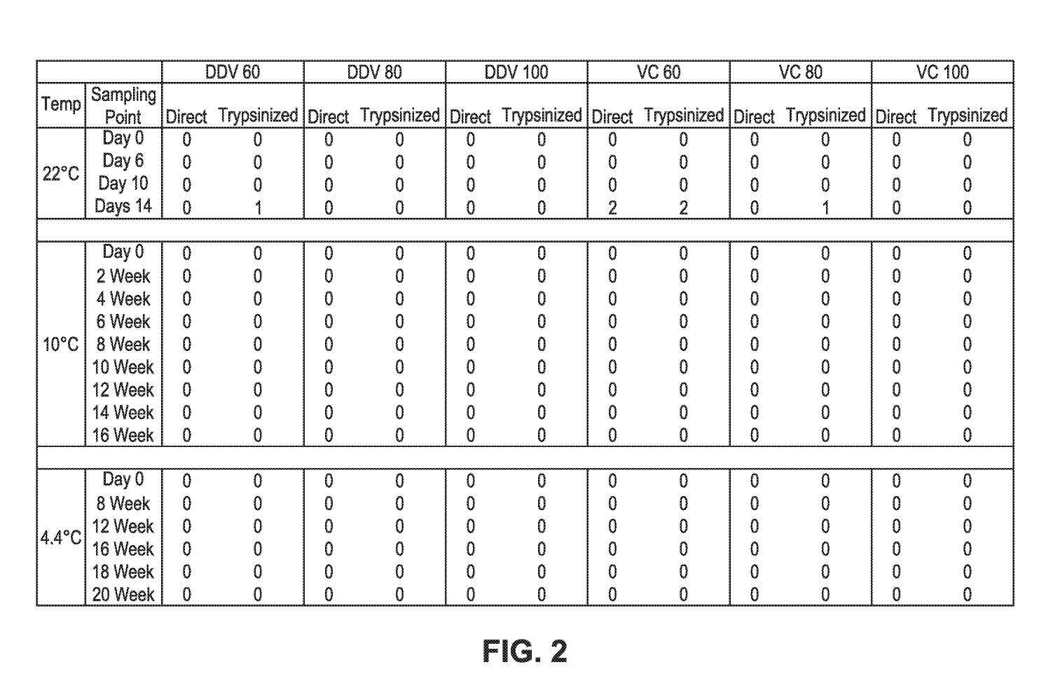

Hot dogs were made according to standard methods containing the additives shown in Table 16. Results are shown in FIGS. 1 and 2

TABLE 16

| | | Anti |
|---|---|---|
| Sample | Nitrite | L. monocytogenes |
| Negative control 60 | Sodium nitrite 60 ppm + | SLSD 2% |
| | erythorbate | |
| Negative control 80 | Sodium nitrite 80 ppm + | SLSD 2% |
| | erythorbate | |
| Negative | Sodium nitrite 100 ppm + | SLSD 2% |
| control 100 | erythorbate | |
| Positive control 0 | — | — |
| Sample 1 DDV 60 | Cultured celery juice powder + | DDV 0.9% |
| | cherry powder (60 ppm nitrite) | |
| Sample 2 DDV 80 | Cultured celery juice powder + | DDV 0.9% |
| | cherry powder (80 ppm nitrite) | |
| Sample 3 DDV 100 | Cultured celery juice powder + | DDV 0.9% |
| | cherry powder (100 ppm nitrite) | |
| Sample 4 VC 60 | Cultured celery juice powder + | VC 2.2% |
| | cherry powder (60 ppm nitrite) | |
| Sample 5 VC 80 | Cultured celery juice powder + | VC 2.2% |
| | cherry powder (80 ppm nitrite) | |
| Sample 6 VC 100 | Cultured celery juice powder + | VC 2.2% |
| | cherry powder (100 ppm nitrite) | |

Beef was chopped, ground, and combined to achieve a target fat content (29-30%). Brine containing ice, salt, dextrose, sodium phosphate, and spices was then added into the mixture. Additionally, appropriate concentrations of synthetic or natural sources of nitrite, cure accelerator, and antimicrobials were included in the brine.

Each formulation was inoculated to a final concentration of 2-3 log CFU per g C. botulinum (0.5% inoculum in sterile water) by mixing for 3-5 minutes to distribute the spores. The spores were mixed into the batter using a prechilled bowl and paddle to maintain temperature of the mix at <4.4° C. After spores were evenly distributed, 75+10 g of inoculated meat was dispensed into boilable, gas impermeable pouches, vacuum sealed and flattened for even thickness (˜10 mm). Sealed packages were then heated in a large water bath (set point 78° C.) until internal temperature reached a minimum of 75° C.

A 10-strain mixture including proteolytic C. botulinum strains 56A, 62A, 69A, 90A, 113B, 213B, Lamanna-Okra B, and nonproteolytic C. botulinum strains Alaska-E, 17B, and Beluga-E were used as a single inoculum mixture.

At each sampling interval [0-time and during storage at 22° C. (6, 10, and 14 days), 10° C. (2, 4, 6, 8, 10, 12, 14, and 16 weeks), and 4.4° C. (8, 12, 16, 18, and 20 weeks)] triplicate inoculated samples were examined for changes in odor, appearance, pH, and presence of botulinum toxin using the mouse bioassay of FDA Bacteriological Analytical Manual, 8th edition). All samples were examined prior to testing for evidence of spoilage due to growth of C. botulinum including development of gas, proteolysis/softening of the product, turbidity in purge, or other signs of sample deterioration. Samples with evidence of changes were preferentially selected for analysis; if no changes were observed, samples were randomly selected for analysis.

Individual samples were then mixed in the package externally by hand, and a representative 25 g portion was aseptically removed into a sterile stomacher bag and homogenized with 50 ml of gel phosphate buffer (pH 6.2). The homogenate was centrifuged (4000 rpm×20 minutes) and presence of botulinum toxin was determined by direct injection of the supernatant (representing proteolytic strains) and supernatant treated with trypsin solution (activates toxin from non-proteolytic strains) using the standard mouse bioassay (FDA BAM, 8th edition). When presence of botulinum toxin was suspected (mouse death), toxin was neutralized by heating suspect sample (80° C. for 20 minutes; Woodburn et al, 1979) and additional mice pairs injected with neutralized and non-neutralized samples to confirm toxicity. Sampling of a treatment was discontinued if toxin was detected in most samples for two consecutive sampling intervals.

Initial populations of C. botulinum after cooking and cooling averaged 2.51+0.46 log spores/g (target 2-3 log spore/g). The results for the toxicity testing are summarized in FIGS. 1 (controls) and 2 (samples).

Inoculated samples at 22° C.: After 6 and 10 days of storage at 22° C., 3/3 samples were positive for botulinum toxin in the positive growth control. Presence of botulinum toxin was accompanied by a decrease in pH at day 6 and observations consistent with growth of C. botulinum. After 14 days storage at 22° C., 3/3 and 2/3 samples were positive for botulinum toxin in treatments Negative Control 60 and VC 60, respectively.

Additionally, 1/3 samples were positive for botulinum in treatment DDV 60 after 14 days. Finally, 1/3 samples were positive for botulinum toxin after 14 days storage for DDV 60. All additional treatments containing a minimum 80 mg/kg nitrite regardless of antimicrobial, were negative for botulinum through 14 days storage at 22° C. Presence of toxin (in toxin positive samples) was not consistent with changes in pH, odor, or appearance.

Inoculated samples at 10° C.: After 2 weeks storage at 10° C., samples were inspected for changes in appearance. Gas development was found in 3 samples in treatment U0 (positive control); the samples were suspected positive for botulinum toxin and therefore tested after 2 weeks storage. No other treatment was tested at 2 weeks as toxin formation in treatments containing nitrite was not expected. After 2 and 4 weeks storage, 2/3 and 3/3 samples were positive for botulinum toxin in the positive growth control. Gas development was observed in these samples; however, no proteolysis was observed. These observations are consistent with growth and toxin production of non-proteolytic C. botulinum. All treatments containing antimicrobials, regardless of nitrite concentration or antimicrobial, were negative for botulinum toxin through 16 weeks storage at 10° C. Although all samples from treatment Negative Control 60 were negative for botulinum toxin, one sample each at 8 and 10-week storage intervals were determined to contain minor gas. No toxin was detected in these samples; however, background microflora did not increase substantially in this treatment throughout 10° C. storage, indicating the gas production was potentially due to growth of C. botulinum. Due to methodology of sample selection, these samples may have become toxin positive had they remained in prolonged storage for additional time.

Inoculated samples at 4.4° C.: All samples, regardless of treatment, were negative for botulinum toxin through 20 weeks storage at 4.4° C. C. botulinum spore populations remained unchanged from inoculation and averaged 2.54+0.47 log spores/g (+0.03 log change) indicating spores remained viable and dormant.

This study confirms storage temperature of less than 4.4° C. for up to 20 weeks will inhibit the growth and toxin production of proteolytic and non-proteolytic C. botulinum in hot dog formulations tested (˜60% moisture, pH <6.3, 2.0% NaCl, a_{w} 0.98) regardless of inclusion of nitrite or antimicrobials. Treatments containing a minimum of 80 mg/kg nitrite, regardless of source, and in combination with 2% SLSD, 0.9% DDV, or 2.2% VC, will inhibit growth and toxin production of proteolytic and nonproteolytic C. botulinum when stored at 10° C. (mild temperature abuse) for 16 weeks. When stored at 22° C. (extreme abuse temperature), 100 mg/kg nitrite in combination with 2% SLSD, 0.9% DDV, or 2.2% VC will inhibit toxin production for 14 days in hot dog formulations.

Modifications and variations will be apparent to those skilled in the art from the forgoing detailed description. All modifications and variations are intended to be encompassed by the following claims. All publications, patents, and patent applications cited herein are hereby incorporated by reference in their entirety.

Although the technology has been described with reference to particular embodiments, equivalents may be employed, and substitutions made herein without departing from the scope of the technology as recited in the claims. Components illustrated and described herein are merely examples that may be used to implement the embodiments of the disclosure and may be replaced with other embodiments without departing from the scope of the disclosure.

What is claimed is:

1. A hot dog having no chemical additives, comprising:
cultured celery juice powder;
cherry powder; and
vinegar;
wherein the hot dog contains no nitrates or nitrites except for those naturally occurring in sea salt and cultured celery juice powder.

2. The hot dog of claim 1 further containing natural liquid smoke.

3. The hot dog of claim 1 wherein the vinegar is dried distilled vinegar.

4. The hot dog of claim 1 wherein the hot dog has substantially equivalent or superior properties to a hot dog containing chemical additives.

5. The hot dog of claim 4 wherein the properties are selected from resistance to microbial growth, appearance, flavor, texture, color, and aroma.

6. The hot dog of claim 1 wherein the hot dog is resistant to growth of C. botulinum for at least 20 weeks at 4.4° C. and at least 16 weeks at 10° C. and wherein the outgrowth of Listeria monocytogenes was under 3 log for at least 76 days at 4.4° C. and at least 21 days at 7° C.

7. The hot dog of claim 6, wherein the outgrowth of Listeria monocytogenes was under 3 log for at least 87 days at 4.4° C. and at least 28 days at 7° C.

8. The hot dog of claim 6, wherein the outgrowth of Listeria monocytogenes was under 3 log for at least 112 days at 4.4° C. and at least 61 days at 7° C.

9. The hot dog of claim 1, wherein the amount of cultured celery juice powder was sufficient to provide about 100 ppm of nitrite.

10. The hot dog of claim 1, wherein the cherry powder is present in an amount between 250 and 469 ppm.

11. The hot dog of claim 1, wherein the vinegar is present in an amount from about 0.3 to 1.2%.

12. A method of making a hot dog that contains no chemical additives, comprising the addition of natural nitrites or nitrates, natural curing accelerant, and natural anti-L. monocytogenes agent.

13. The method of claim 12, wherein the natural nitrite is cultured celery juice powder, the natural cure accelerant is cherry powder, and the natural anti-L. monocytogenes agent is dried distilled vinegar.

14. The method of claim 13, wherein the hot dog has substantially equivalent or superior properties to a hot dog containing chemical additives.

15. The method of claim 14 wherein the properties are selected from resistance to microbial growth, appearance, flavor, texture, color, and aroma.

16. The method of claim 12 wherein the hot dog is resistant to growth of C. botulinum for at least 20 weeks at 4.4° C. and at least 16 weeks at 10° C. and wherein the outgrowth of Listeria monocytogenes was under 3 log for at least 76 days at 4.4° C. and at least 21 days at 7° C.

17. The method of claim 13, wherein the amount of cultured celery juice powder was sufficient to provide about 100 ppm of nitrite.

18. The method of claim 13, wherein the cherry powder is present in an amount between about 250 ppm and 469 ppm.

19. The method of claim 13, wherein the vinegar is present in an amount from about 0.3% to 1.2%.

20. A method of making an all-natural hot dog having substantially equal or better properties to a prior art hot dog containing the six chemical additives sodium nitrite, sodium lactate, sodium diacetate, sodium erythorbate, hydrolyzed soy powder, and artificial smoke flavor comprising including in the hot dog none of the six chemical additives and including the four all-natural additives cultured celery juice powder, cherry powder, dried distilled vinegar, and natural liquid smoke.
